(19) United States
(12) Patent Application Publication
(10) Pub. No.: US 2019/0075816 A1
(43) Pub. Date: Mar. 14, 2019

(54) METHOD TO PRODUCE ICE CREAM AND FROZEN DESSERT DRY MIX WITH ENHANCED SOLUBILITY AND HYDRATION PROPERTIES

(71) Applicant: Tangent foods International limited, Grand Cayman (KY)

(72) Inventor: Jareer Mansour Abu-Ali, Phitsanulok (TH)

(73) Assignee: Tangent foods International limited, Grand Cayman (KY)

(21) Appl. No.: 16/190,978

(22) Filed: Nov. 14, 2018

Related U.S. Application Data
(63) Continuation of application No. 15/118,110, filed on Aug. 11, 2016, now abandoned.

(30) Foreign Application Priority Data
Feb. 13, 2014 (TH) 1401000779
Feb. 12, 2015 (TH) 1501000747

(51) Int. Cl. A23G 9/52; A23G 9/38; A23G 9/46

(52) U.S. Cl. CPC A23G 9/52; A23G 9/46; A23G 9/38

(57) ABSTRACT

A method produces a modular dry mix that can easily be modified and customized to produce a wide range of easy to aerate, no ice cream machine needed, ice cream and frozen desserts and products made. The method relies on successive simultaneous particle size reduction and blending steps without the use of traditional mix drying operations. A product produced from this mix consists of a (protein-concentrate and emulsifier)—stabilized, protein-based foam created by combining a powder mix with one or a combination of a large range of above freezing temperature liquids then immediately whisking the mixture at room temp to a target overrun without pre-aging, and then freezing that product statically till desired hardness is achieved. The process involves the use of dry powders that are transported and sold dry and then reconstituted by the end user before they are combined without pre-treatment, freezing homogenization or aging.

### FIELD OF THE INVENTION

This invention relates to dairy and non-dairy dessert products for home use with powder to make ice cream and frozen desserts.

### DESCRIPTION OF THE RELATED ART

Ice cream and related frozen dairy and non-dairy desserts are a major food industry with estimated annual sales approaching 66 billion USD annually. Ice cream is thought to have originated in the time of the ancient romans. There have been recorded histories of Emperor Nero ordering ice to be brought down from the mountains and then mixed with fruits or honey and consumed as a refreshing dessert. Modern ice cream and similar frozen desserts are reported to have first originated in Arabia, where Arab craftsmen would mix cream with sugar, yogurt and rose water then chill the resulting mix by adding it to ice.

The Chinese are credited with inventing the first systematic methods to produce ice cream where they would add the ingredients into metal pots and place the pots in a mixture of ice and salt which depresses the freezing point of the ice and causes the sweetened mixture inside to freeze more solid. The first patent for the modern mechanized for making ice cream was granted to Nancy Johnson of Philadelphia in 1843. Mrs. Johnson's hand-cranked machine utilized the same general principles being used today for home and commercial ice cream manufacturing.

Chemically, ice cream and similar frozen dairy and non-dairy desserts comprise a foam, a solution, and a colloidal suspension. When using natural fluids such as milk and cream to prepare the dessert, the colloidal suspension and most of the solution already exist. To these, further dry ingredients such as sweeteners, stabilizers and flavors can be added. To create the foam portion, the mix is agitated or “beaten” while simultaneously being cooled to increase its viscosity in an effort to entrap air. The entrapment of air, measured by a term called overrun, is important to the quality of the ice cream as it contributes lightness, firmness and gives body to the ice cream. During the beating process, the air bubbles being forced into the mixture begin to get coated with some of the fat and protein found in the mixture which helps stabilize them and create the rough foam that sets the backbone of the aerated dessert structure. FIG. 1 provides a microscopic view and diagram illustrating the different substances, air bubbles and fat globules in an ice cream.

The fat globules and protein molecules align themselves on the air/solution interface. It is the protein network that creates the ultimate foam structure by acting as a surfactant that holds the air bubbles and attaches them to the water. The size and distribution of these fat globules determines how well the coat the air bubbles and ultimately how stable foam comprising the finished dessert is during processing, freezing a distribution. This is partially, the other reasons being mouth feel and separation resistance, why traditional ice cream and frozen dessert mixtures require homogenization that breaks up the large fat globules into smaller fat globules that can better fit around the air bubbles, interact with the proteins and help stabilize the foam. FIG. 2 shows such fat structure in ice cream.

In conventional ice cream making, the ingredients are added as a solution to a refrigerated drum with a central mixing shaft, as the drum and the mixing shaft rotate the solution beings to freeze due to contact with the internal walls of the rotating drum. As the solution rotates and freezes, the mixing shaft beats air into the solution, simultaneously lightening and stiffening the mixture into the texture and mouth feel associated with frozen dairy desserts like ice cream. This process has been virtually unchanged since the time of its inception in the 19th century. While small modifications to the machines such adding pressure and improved freezing and pumping capabilities have been made in addition to improvements in ingredients and stabilizers, the central principle behind ice cream making has remained the same.

The purpose of the rotating drum and or air incorporation devices is to force air into the mix which with the help of emulsifiers to disrupt the complete coalescence of the fat portion of the solution (that has undergone particle size reduction during homogenization) and to help arrange it into partially coalesced chains that form structures that entrap air (or aeration gas) thereby increasing the volume of the mix and simultaneously lightening its texture upon freezing and firming up the resulting structure and increasing its resistance to melting.

By their nature, modern ice cream making systems are energy intensive and cumbersome, necessitating large amounts of energy to handle and prepare the ingredients and then more energy in the ice cream machines as these machines try to rapidly and controllably freeze the solution while aerating it before the fat can fully coalesce. Because of this nature and the need to store and prep the ingredients in steps such homogenization, ice cream factories usually will occupy large physical footprints and require significant capital investment which in turn limits entry into the market and inhibits innovation.

The energy consumption associated with ice cream, and related frozen dairy desserts, comes with a heavy environmental impact in terms of pollution. The need to maintain the product in frozen condition throughout its distribution and sales cycle and the use of often non-recyclable containers further adds to environmental impact.

Currently, powdered food mixes in general and ice cream/frozen dessert mixes for home machines in particular, are generally made by one of two main methods:

1) Drying of liquid mixes: in this method, the desired ingredients are made into a liquid solution or slurry and then dried. Common drying methods include drum drying, spray drying and vacuum drying. These processes allow the mixing of the ingredients and their binding together so that the finished powder mix is homogenous on the macro scale at least and is less likely to separate during distribution. There are several challenges associated with these processes, however, including:

When several immiscible materials are used in one mix such as mixes that contain fat soluble and water-soluble ingredients, surfactant materials such as emulsifiers must be added to the liquid mix. When the liquid mix is then dried, the resulting powder resembles the distribution of the micelles in the liquid solution, to a certain extent, and the process merely “sticks” the different portions of the solution together without necessarily fusing them together or arranging them in a fashion that optimizes their solubility.

A second challenge arises when gelling and swelling ingredients such as hydrocolloids or starches are added into the mix. Because these drying processes are affected by viscosity, the rate at which these gelling ingredients are allowed to hydrate must be controlled tightly which, when combined with the fat/water post-drying arrangement described earlier, might affect their hydration rate in the finished product and their functionality

These processes are expensive requiring significant upfront investment in terms of dollars (ranging from 10's of thousands to millions) and in space and training in addition to significant ongoing cost of production. Traditionally these machines occupy large areas of the manufacturing facility and require dedicated infrastructure to operate and maintain them. These limitations have restricted the use of these methods to medium-large manufacturers which in turn has significantly restricted innovation in this area.

Products made by these processes are “locked” in that they are very difficult to customize. In order to customize these products, new liquid formulas must be developed which then need to be tested for their drying properties. Small scale rapid testing of new formulations is also difficult as the equipment and preparation required to run even pilot plant level batches is both time consuming and costly

The nature and cost of the equipment make scaling up operations or dispersing operations geographically (wither to reduce their carbon footprint or diffuse the technology) both difficult and expensive. These operations consume large amounts of energy and contribute to the pollution problem.

2) Dry Blending: in this process, the dry ingredients are all added together in a mixer that uses mechanical motion to mix the different components into a homogenous mixture. This process is considered one of the cheapest powder mix production methods but also has several challenges including:

Mixtures prepared by this method can easily separate during shipping and handling as the process does not include a “binding” step to fuse the ingredients together. Separation of the ingredients can cause significant challenges to their functionality and how they perform in the finished product especially when packed in multi-serving packs.

Because the ingredients are not bound together, their solubility during the rehydration step is limited to the native solubility of the components. In mixes containing water soluble and fat-soluble components, separation in the finished product due to lack of proper emulsification might occur which would negatively impact quality and stability. Furthermore, because the ingredients are not fused together, special operations such as homogenization and aging must be employed to ensure proper distribution of fat around the air cells and the disruption of the fat chains which would otherwise give a filmy, oily, tongue-coating mouth feel especially in frozen desserts using vegetable fats instead of dairy fat.

In mixes containing hydrocolloids, failure to properly distribute the hydrocolloids in the mixture may result in lumps and poor hydration, both of which impact quality and stability negatively.

There are well known disadvantages of commercial ice cream set-ups:

The typical ice cream plant is very expensive to set up and involves several unit operations to receive and refrigerate incoming ingredients, blend ingredients, homogenize mixes, make the ice cream in machines, fill into cups and ultimately freeze;

Because of the requirements described above, ice cream plants require a large footprint, consume allot of energy and require allot of sanitation;

Ice cream products produced in the traditional fashion require large, centralized manufacturing facilities that then ship their finished frozen products using expensive, energy intensive frozen shipping to distribution points and stores;

Ice cream products produced traditionally can also stay at the retailer for several months before being sold to the customer, during this time it continues to consume large amounts of energy in the frozen display case;

Because of their requirements for energy and sanitation byproducts during their entire product cycle from farm to consumer, ice cream factories have a very large carbon foot print and contribute a great deal to pollution from their energy use and from handling their waste materials and the by-products of their handling and operations;

There are also well-known disadvantages of home ice cream machines such as:

Its initial (purchase) and ongoing (electricity) cost, and limited availability;

Home ice cream machines may be single use machines that require a significant amount of use before they provide a positive return on investment when compared to buying pre-made ice cream at the store;

All ice cream makers on the market by their nature can only produce one flavor at a time which, when combined with the disadvantages listed below, makes their use very limited and time consuming;

Most ice cream machines require pre-freezing the freezing drum for up to 12 hours before use. Those that don't require pre-freezing require cumbersome set-ups of ice and salt that are difficult and messy to set up or clean;

Machines that don't require pre-freezing are expensive and can produce only small quantities of one flavor at a time with a minimum of 1-2 hours of time between batches;

Due to their nature, these machines cannot control the overrun value of the ice cream and can essentially produce only one overrun value thus limiting the range of products.

There are also disadvantages of home recipes:

Most are time consuming and involve large amount of preparation time and many steps including cooking;

All require the use of highly perishable, expensive and not always readily available (depending on geographic region) ingredients such as liquid cream, milk, sugar and the like;

Most require several intermediate steps after mix prep and during the freezing process which means they need constant attention/attendance for several hours;

Most cannot independently control overrun and total solids and produce only one flavor at a time.

The very few home processes that do not require cooking rely on ingredients with very high levels of sugar, fat and dissolved solids which significantly limits their ability to freeze under normal home refrigeration conditions and limits their use to very dense, very sweet, high fat, unstable desserts that will only partially freeze in even the most expensive of home cryo-freezers. Due to the lack in balance of density of the components in these methods and the lack of emulsifiers and stabilizers, these products are not stable and often exhibit separation during either prep or storage.

### SUMMARY OF THE INVENTION

The objectives of this invention are the following:
to provide a new powder-mix preparation process;
to develop a method to produce high solubility, easy to customize ice cream and frozen dairy and non-dairy dessert powder mixes that produce highly stable foams that don't create an oily mouth feel;
to produce a, preferably shelf-stable, powdered ice cream mix that can be easily and quickly prepared, customized and frozen in the home or factory using standard home and factory appliances and freezers without the use of ice cream machines or elaborate ice cream manufacturing set-up.

The invention seeks to do this with reduced costs and time along with a scale up processing method that increases innovation and competitiveness in the category by democratizing and decentralizing the process.

A process for producing an ice cream or frozen dessert powder mix is disclosed. The process includes grinding or blending ingredients at 300 to 1000 rotations per minute (RPM) and at a low shear angle. The process also includes grinding or blending the ingredients at 3500 to 5000 RPM and a high shear angle. The process also includes ambient cooling the ingredients. The process also includes grinding the ingredients at 300 to 1000 RPM and the low shear angle.

The process also includes mixing the ingredients at 300 to 1000 RPM and the low shear angle. The process also includes producing a powder mix from the ingredients having a particle size between 0.3. millimeters to 0.6 millimeters.

The ingredients include a first mixture of a high purity powdered protein source having between 70-99% protein by weight, a high-melt powdered emulsifier, and at least one of a powdered form of Arabic gum, locust bean gum, guar gum, and powdered salt. The first mixture is combined with at least one of a powdered vegetable or animal-based fat source, powdered sucrose, powdered sucrose substitutes, and powdered bulking agents at 300 to 500 RPM. The powdered sucrose substitutes include sugar alcohols or soluble fiber. The powdered bulking agents include glucose syrup solids, maltodextrine, or starch.

The disclosed process also includes that the powder mix contains 0 to 24.9% or 36 to 45% by weight sucrose or sucrose substitutes, 0 to 10% or 16 to 50% by weight vegetable or animal fat, 2 to 7% or 20 to 45% by weight high purity protein source, 0 to 1.5% or 10 to 20% by weight stabilizer, 0.3 to 20% to 40% by weight above room temperature melting emulsifier, and 0.1 to 0.3% or 2 to 5% by weight salt. The stabilizer includes at least one of Locus bean gum, guar gum, Arabic gum, Taragacanth gum, and Fenugreek gum. The melting emulsifier includes at least one of the distilled mono-glycerides, mono and diglycerides of fatty acid blends, sucrose esters of fatty acids, DATEM, and polyglycerol esters of fatty acids.

A process to produce ice cream or frozen desserts using the powder mix is disclosed. The process includes forming a protein-stabilized foam. The foam is created by whipping or aerating the powder mix after reconstitution with a cold liquid. The process also includes molding the foam into a desired shape. The process also includes freezing the molded foam. The process also may include reconstituting the powder mix using a cold liquid at a temperature between −6 degrees to 6 degrees Celsius. The process also may include mixing the cold liquid and the powder mix to create a foam. The process also may include aerating the foam at ambient temperature to an overrun of 90 to 135%. A temperature of the foam is greater than a temperature of the cold liquid. The process also may include freezing the foam into the product.

The product includes a solid mixture of nuts, candy pieces, chocolate pieces, fruits, marshmallows, sugar-based confections, cocoa powder, or cookies. The solid mixture is 39 to 47% of the total weight of the product.

### BRIEF DESCRIPTION OF DRAWINGS

FIG. 1 illustrates a microscopic view and diagram illustrating the different substances, air bubbles and fat globules in an ice cream.

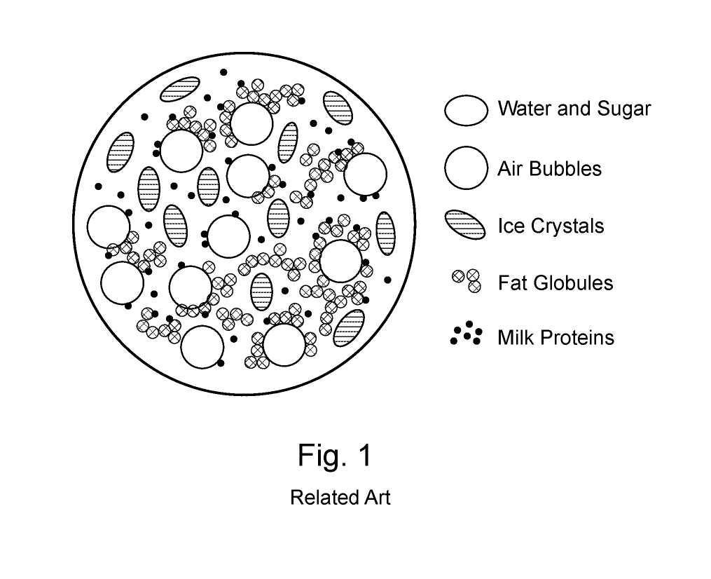

FIG. 2 illustrates a diagram showing the fat structure in ice cream.

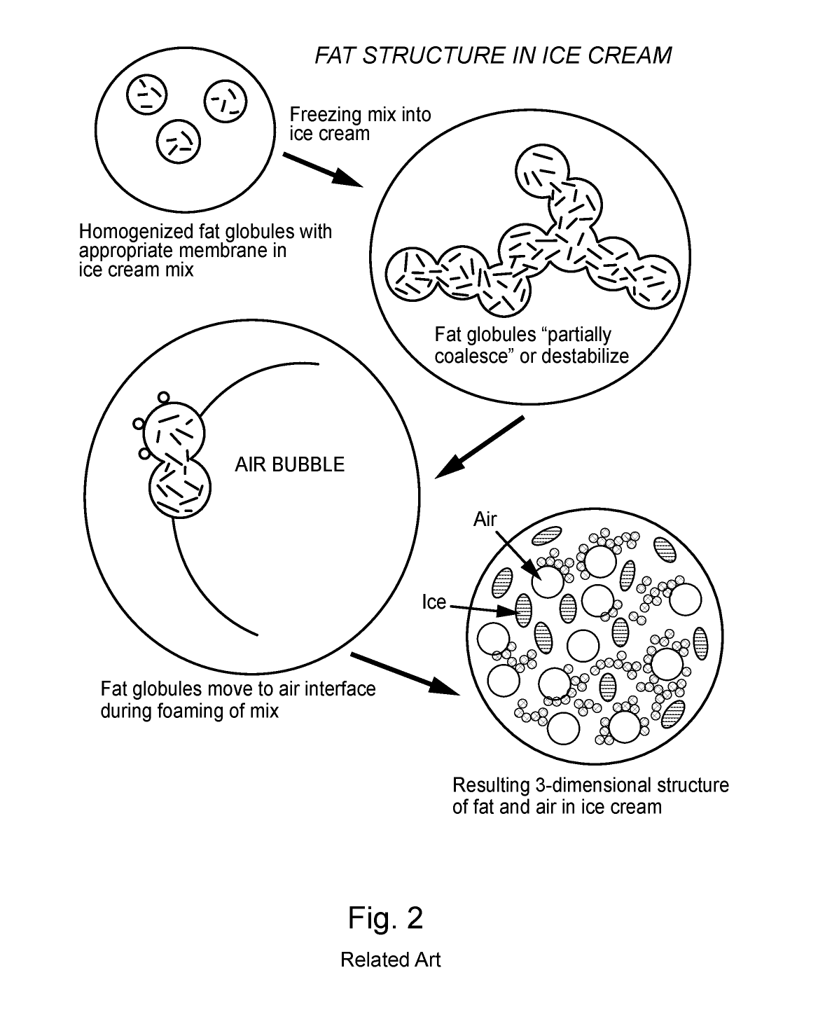

FIG. 3A illustrates a system for producing an ice cream of frozen dessert powder mix according to the disclosed embodiments.

FIG. 3B illustrates a flowchart for producing an ice cream of frozen dessert powder mix according to the disclosed embodiments.

FIG. 3C depicts a flowchart for producing ice cream or frozen desserts using the powder mix according to the disclosed embodiments.

FIG. 4 illustrates a low to medium speed blender according to the disclosed embodiments.

FIG. 5 illustrates a high-speed blender according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

This invention relates both to a new powder mix making process and a new mix formulation as described below.

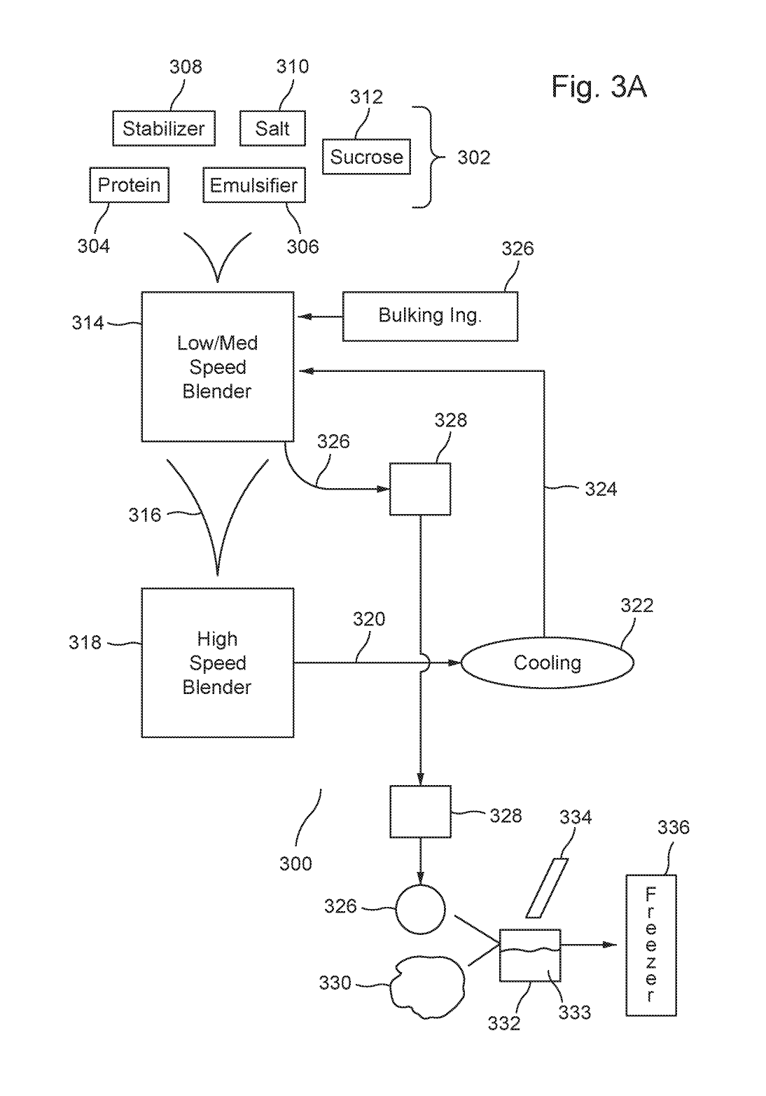

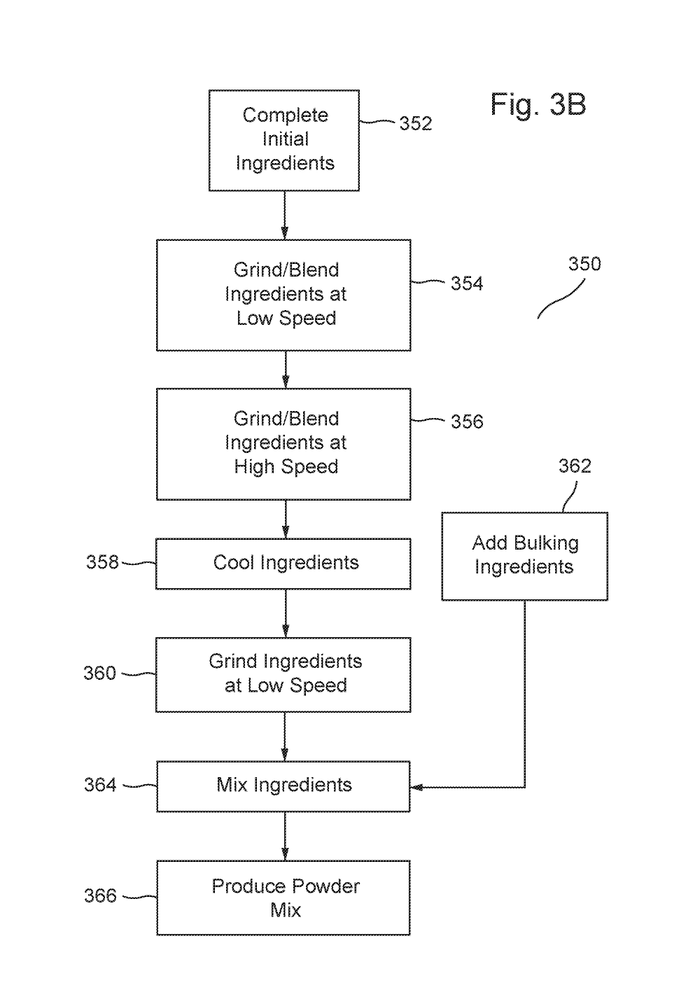

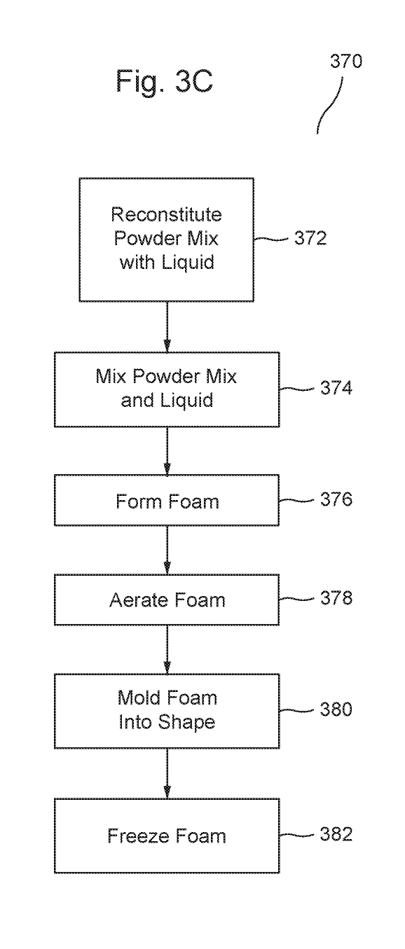

FIG. 3A depicts a system 300 for producing an ice cream or frozen dessert mix according to the disclosed embodiments. FIG. 3B illustrates a flowchart 350 for producing an ice cream of frozen dessert powder mix according to the disclosed embodiments. System 300 may include two blenders. Blender 314 may be a low to medium speed blender that operates at about 300 to about 1000 rotations per minute (RPM). Blender 314 may implement a low shear angle for its blades. Blender 318 may be a high-speed blender that operates at about 3500 to about 5000 RPM. Blender 318 may implement a high shear angle for its blades.

1) The powder mix making process:

The process described in this invention entails the steps disclosed in FIG. 3B set out in two stages; the first describes the creation of an “active” component and the second describes combining that active component with a “bulking” component. First stage: The active component.

The active component contains a purified, concentrated protein source 304 (protein content 35-99% net protein content), an emulsifier 306 (distilled monoglyceride), a stabilizer 308 (hydrocolloid and or modified starch), salt 320 and a carrier such as sucrose 312. These items may be shown as initial ingredients 302 in FIG. 3A. The active component is made in the following processes:

Process 1: Step 352 executes by combining initial ingredients 302. The dry ingredients are placed into a vertical grinder/blender 314 with 4 horizontal blades in an “+” pattern. The powders are fed into the mixer perpendicular to the blades. The blades are sharpened on one edge and blunt on the other. Step 354 executes by grinding or blending the initial ingredients so that they are simultaneously mixed and coarse-ground at low speed of about 300 to about 1000 RPM and at a low angle of shear. This steps breaks up clumps, homogenizes the mixture and begins to reduce the particle size of the ingredients

Process 2: The homogenized, free-flowing mixture 316 is removed from the grinder/blender 314 in the first process and placed in a high-speed blender/grinder 318 consisting of very sharp blades set at a high angle. Step 356 executes by grinding or blending ingredients at a high speed of about 3500 to 5000 RPM. As the blades turn, they significantly reduce the particle size of the mixture components including the hydrocolloids which are now finely ground and thoroughly dispersed among the other components of the mix. As the grinding/blending continues, the high shear rate and shear angle cause high friction with the particles of the mix and heat is generated. As the components begin to heat up while being sheared and blended, the distilled mono-glyceride (emulsifier) begins to melt and flow. As the process continues the emulsifier coats the other components thoroughly and fuses with them while binding all the ingredients of the active component together. At this point, the mixture goes from free flowing to the formation of powder sheets 320 that breakup easily. At this point the product 320 is removed from the high shear grinder/blender and allowed to cool in step 358 at cooling location 322.

This coating step where the emulsifier coats and fuses to the proteins and the hydrocolloids is very important as it will later help the components of the active mix to more easily and quickly dissolve in liquid, allow the fat to better coat the air bubbles while simultaneously disrupting the fat chains to create stronger foams that don't leave a film, and allow the hydrocolloids to hydrate rapidly during the preparation of the finished dessert which will allow them to hold more air and resist separation. Because this is done without the direct application of heat, there is no damage to the taste or functionality of the active components. Instead, step 358 allows product 320 of powder sheets to cool naturally.

Process 3: Step 360 executes by grinding cooled active mix 324. The active mix is placed back in low-medium speed, low shear angle blender 314 which breaks up the sheets of powder into a free flowing, fine particle homogenous mixture once more. Blender 314 may operate at about 300 to about 1000 RPM.

Stage two: Combining the active component with a “bulking” component:

Process 4: The final mix: Step 362 executes by adding bulking ingredients 326. The bulking ingredients which can include sweeteners, fats, dairy powders, and the like are combined with the active mix component 324 in the low shear angle mixer 314. Step 364 executes by mixing the ingredients in blender 314 at about 300 to about 1000 RPM. Blender 314 works to combine the ingredients while reducing their size and to provide enough friction and heat to fuse the fat-coated active to the rest of the bulking ingredients. Step 366 executes by producing powder mix 326, which may be placed in container 328.

2) The formulation:

The formulation described in this invention comprises a product made by the process described above. A typical formulation may comprise the following:
Sucrose: 12%
Powdered vegetable fat/dextrose mixture: 80%
Milk protein: 2.5%
Stabilizers (ex: guar, LBG, Taragacanth): 1.25%
Mono-glyceride emulsifier: 2%
Maltodextrine: 2.25%

A finished product is made from the above-described powder mix 328. The product comes in a complete package or container 328, and is completely water soluble at room temperature and below. FIG. 3C depicts a flowchart 370 for producing ice cream or frozen desserts using powder mix 328 according to the disclosed embodiments. Powder mix 328 may be combined with cold liquid to produce foam 333 that is crafted into the finished frozen product. Flowchart 370 may be implemented using components 328-338 shown in FIG. 3A.

Step 372 executes by reconstituting powder mix 326 using a cold liquid 330. The end user may add water or liquid, such liquid preferably at a temperature comprised between −6 and 6° Celsius. As shown in FIG. 3A, powder mix 326 and liquid 330 may be combined in container 332. Step 374 executes by mixing powder mix 326 and liquid 330.

Step 376 executes by forming a protein-stabilized foam 333. Step 378 executes by aerating foam 333 at an ambient temperature, such as room temperature, or about 22 to 26 degrees Celsius. Foam 333 may be aerated to overrun of 90 to 135%. Whisking or aerating tool 334 may whisk at high speed till the mixture more than doubles in volume to generate foam 333. The temperature of foam 333 should be higher than the temperature of liquid 330. Step 380 executes by molding foam 333 into a shape. Further, other ingredients may be added at this step. Step 382 executes by freezing foam 333 in freezer 336. Freezer 336 may a device having a temperature below 0 degrees Celsius. The mixture including foam 333 is placed in freezer 336 and allowed to freeze till the desired hardness is achieved.

The semi-firm foam mixture created during preparation allows the addition of a number of items prior to freezing. The emulsification properties of the precisely rationed milk proteins, ionic gums and emulsifiers allow rapid, smooth mixing without the destruction of the foam or separation of the liquid phase during preparation, customization and freezing. The product is quickly prepared (less than 6 min) and requires only 2-3 steps with no need for pre-aging, cooking, ice cream machines or intermediate steps. The unfrozen product is stable at room temperature for longer than equivalent traditional ice cream mixes both commercial and home use. This stability allows for extended manipulation of the product prior to freezing including the ability to mold the product into shapes, which is not possible with any home or commercial ice cream mixes. The product is low cost compared to other ice cream/frozen dessert mixes on the market or pre-made ice cream. The product freezes readily in standard home freezers and requires no special treatment. The product is modular and enables the untrained end user to customize nearly all aspects of the product from overrun to texture, flavor, color, mouth feel and melting profile. The product produces a stable product that is stable to both freeze-thaw and temperature fluctuations even in home refrigerators.

By varying the protein source and or the fat source, the product nature can be quickly and completely transformed to create distinct products such dairy based traditional ice creams, vegetarian ice creams, vegan ice creams and several other varieties without having to change the manufacturing process or invest significant time and resources in recipe development. The heating-free “fusing” nature of the powder mixing process allows the mixture to be an effective carrier for other materials such as pharmaceutical compounds, and cosmetic supplements.

By conceptually deconstructing ice cream, stabilizing the components and reincorporating into stable, easily manipulated products, this invention seeks to present an alternative method to produce and distribute ice cream and related frozen desserts that would be dramatically cheaper and have a significantly lower environmental impact.

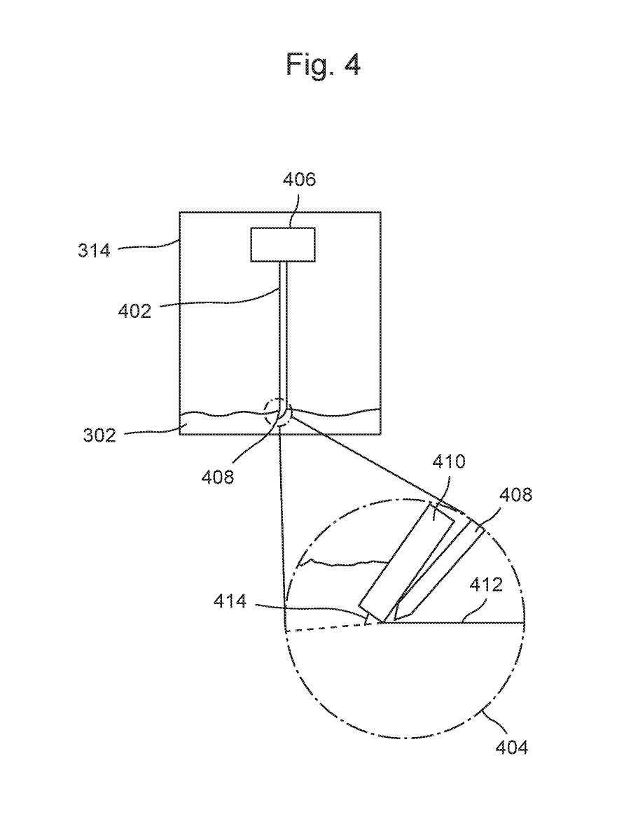

FIG. 4 depicts low to medium speed blender 314 according to the disclosed embodiments. Blender 314 includes blades 402 rotated by rotating device 406. Rotating device 406 may operate at set speeds according to the disclosed embodiments. As disclosed above, the preferred speeds are about 300 to 1000 RPM. Blades 402 also may have a “+” configuration in that one set of blades is perpendicular to the other set of blades. For brevity, blade 402 is shown in FIG. 4. Blade 402 includes grinding blade end 408.

Blender 314 may be a vertical blender that receives initial ingredients 302 to be mixed into the active mix, as disclosed above. Other ingredients also may be placed into blender 314, such as cooled product 324. As blades 402 rotates, a particle 404 of the mix or ingredients in blender 314 is ground or broken into separate components to create a mix having a particle size of about 0.3 millimeters to 0.6 millimeters. Particle 404 is broken into chip 410 by blade end 408. Blade end 408 is sharp in order to separate particle 404 along a cutting plane 412.

Blender 314 may cut particle 404 at a low shear angle 414. Low shear angle 414 also may be known as a low shear plane angle. As can be seen, low shear angle 414 is the angle between cutting plane 412 of blade end 408 and a plane where chip 410 separates from particle 404 as blade end 408 engages particle 404. Preferably, low shear angle 414 is less than 45°. More preferably, low shear angle 414 is about 30°.

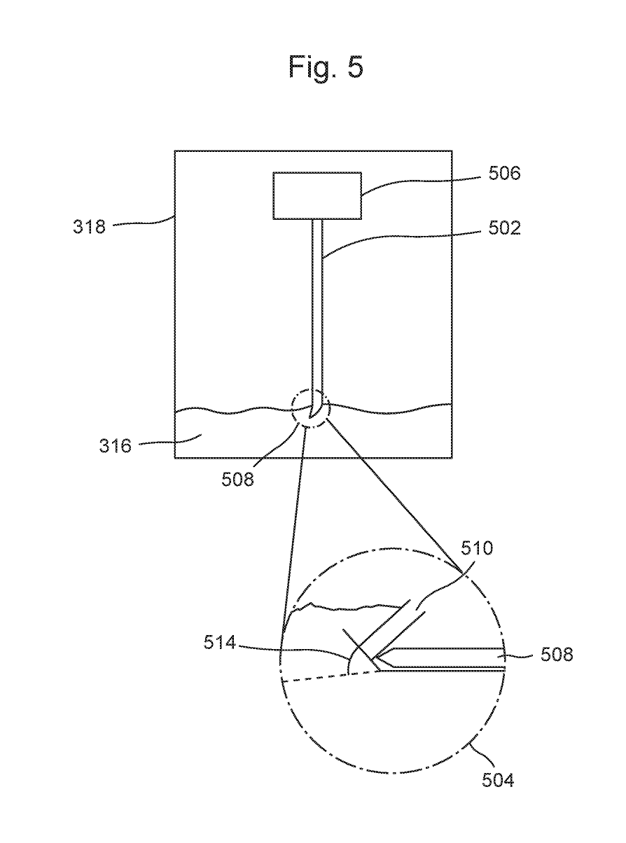

FIG. 5 depicts high speed blender 318 according to the disclosed embodiments. Blender 318 may resemble blender 314 with blades 502 moving in the horizontal direction to grind or blend the mix particles, or mixture 316 in FIG. 3A. Blender 318 includes blades 502 rotated by rotating device 506. Rotating device 506 may operate at set speeds according to the disclosed embodiments. These speeds are higher than rotating device 406 in blender 314. As disclosed above, the preferred speeds are about 3500 to 5000 RPM. Blades 502 also may have a “+” configuration in that one set of blades is perpendicular to the other set of blades. For brevity, blade 502 is shown in FIG. 5. Blade 502 includes grinding blade end 508.

Blender 318 may be a vertical blender that receives mixture 316 from blender 314, as disclosed above. As blades 502 rotates, a particle 504 of mixture 316 is ground or broken into separate components as well as generate the features disclosed above. The resulting mix may be finer or have smaller particles than that of mixture 316. Particle 504 is broken into chip 510 by blade end 508. Blade end 508 is sharp in order to separate particle 504 along a cutting plane 512.

Blender 318 may cut particle 504 at a high shear angle 514. High shear angle 514 also may be known as a high shear plane angle. As can be seen, high shear angle 514 is the angle between cutting plane 512 of blade end 508 and a plane where chip 510 separates from particle 504 as blade end 508 engages particle 504. Preferably, high shear angle 514 is greater than 45°. High shear angle 514 is greater than low shear angle 414. The greater shear angle results in a finer chip 510 because of a smaller shear plane during grinding. It also provides the features disclosed above.

Main advantages of the powder production process of this invention include the following:
the powder production process is cost effective with low upfront investment, low infrastructure investment, and easy scale up;
low operator training needs and easy operation;
increases the solubility of the mix;
improves the hydration rate of the hydrocolloid portion of the mix;
the mixing process allows for better fusion of emulsifier and protein molecule which improves the coating of air pockets in the ice cream with fat which improves the foam stability and its resistance to temperature shock, while simultaneously disrupting the fat chains in a way as to eliminate any oil mouth feel
produces a more stable gel framework in the finished product and increases its stability;
produces a mix that doesn't require ageing or pretreatment;
produces a mix that can have overrun above 130%;
the process allows for the rapid development of viscosity in the finished product mixture and increased water-holding capacity without the use of food acids;
creates a “platform” mix that can be easily and quickly customized to create distinct offerings such as vegan and non-dairy.

There are also several main advantages of the formulation and finished product including:

Cost: due to the use of powdered ingredients that are shelf stable and don't require ice cream machines, this product is significantly cheaper in manufacturing, distribution and sale costs than traditional ice cream for both home or commercial use;

Convenience: because the ingredients in the preferred execution are shelf stable and can be made in short time (<6 min) using common home utensils with no prior training, the product can be made at home when desired and in the quantities desired on short notice.

Customization: the modular nature of the product and way this product is prepared allows the consumer to control both the total solids and the overrun of the finished product semi-independently thus enabling the creation of several different types of ice cream or frozen desserts which when coupled with the addition of colors and flavors to sub-batches during prep exponentially increase the number of customized products that can be produced in short time from the same unit of the product;

Creativity: the modular nature of the product also allows the end user to creatively add ingredients to the product while giving them the ability to adjust for their effect on the finished product properties thus allowing the creation of highly customized desserts;

Clean: the product takes out a great deal of energy and associated pollution from the ice cream production and distribution cycle by using a shelf stable dehydrated mix that requires far less energy to transport, store, distribute and prepare. The fact that the format shifts the freezing responsibility for the product from the commercial ice cream machines, hardening freezers, storage freezers, frozen transport trucks and frozen displays to the always on anyway home freezers in effect increases the energy cost efficiency of those freezers. The fact this product requires a relatively small manufacturing foot print can help revolutionize the manufacturing process by creating several small, local “prep” facilities in the target distribution area that can make the product on near-demand and reduce the costs for freezing, storage and distribution. Because the product is made at home, there is also a great deal of savings in terms of packaging and containers thus reducing landfill usage and non-biodegradable waste.

Thus, the disclosed embodiments set forth a novel process that facilitates the mixture and production of a powder mix for ice cream and frozen desserts without the use of machines or complicated processes. One may produce desired frozen items in their home and without the need for specialized equipment. The preceding examples can be repeated with similar success by substituting the generically or specifically described reactants and/or operating conditions of this invention for those used in the preceding examples. From the foregoing description, one skilled in the art can easily ascertain the essential characteristics of this invention and, without departing from the spirit and scope thereof, can make various changes and modifications of the invention to adapt it to various usages and conditions.

1-13. (canceled)

14. A process for producing an ice cream or frozen dessert powder mix, the process comprising:
grinding or blending a plurality of ingredients at 300 to 1000 rotations per minute (RPM) and at a low shear angle;
grinding or blending the plurality of ingredients at 3500 to 5000 RPM and at a high shear angle;
ambient cooling the plurality of ingredients;
grinding the plurality of ingredients at 300 to 1000 RPM and at the low shear angle; and
mixing the plurality of ingredients at 300 to 1000 RPM and at the low shear angle to produce a powder mix from the ingredients having a particle size between 0.3 millimeters to 0.6 millimeters.

15. The process of claim 14, wherein the plurality of ingredients includes a first mixture of a high purity powdered protein source having between 70-99% protein by weight, a high-melt powdered emulsifier, and at least one of a powdered form of Arabic gum, locust bean gum, guar gum, and powdered salt.

16. The process of claim 15, wherein the first mixture is combined with at least one of a powdered vegetable or animal-based fat source, powdered sucrose, powdered sucrose substitutes, and powdered bulking agents at 300 to 500 RPM.

17. The process of claim 16, wherein the powdered sucrose substitutes include sugar alcohols or soluble fiber.

18. The process of claim 16, wherein the powdered bulking agents include glucose syrup solids, maltodextrine, or starch.

19. The process of claim 14, wherein the powder mix contains 0 to 24.9% or 36 to 45% by weight sucrose or sucrose substitutes, 0 to 10% or 16 to 50% by weight vegetable or animal fat, 2 to 7% or 20 to 45% by weight high purity protein source, 0 to 1.5% or 10 to 20% by weight stabilizer, 0.3 to 20% or 20 to 40% by weight above room temperature melting emulsifier, and 0.1 to 0.3% or 2 to 5% by weight salt.

20. The process of claim 19, wherein the stabilizer includes at least one of Locus bean gum, guar gum, Arabic gum, Taragacanth gum, and Fenugreek gum.

21. The process of claim 19, wherein the melting emulsifier includes at least one of distilled mono-glycerides, mono and diglycerides of fatty acid blends, sucrose esters of fatty acids, and polyglycerol esters of fatty acids.

22. A process to produce ice cream or frozen desserts using the powder mix made by the process of claim 14, the process comprising:
forming a protein-stabilized foam, wherein the foam is created by whipping or aerating the powder mix after reconstitution with a cold liquid;
molding the foam into a desired shape; and
freezing the molded foam.

23. A process for making an ice cream or frozen dessert product made using the powder mix made by the process of claim 14, the process comprising:
reconstituting the powder mix using a cold liquid at a temperature between −6 degrees to 6 degrees Celsius;
mixing the cold liquid and powder mix to create a foam;
aerating the foam at ambient temperature to an overrun of 90 to 135%, wherein a temperature of the foam is greater than a temperature of the cold liquid; and
freezing the foam into the product.

24. The process of claim 23, wherein the product includes a solid mixture of nuts, candy pieces, chocolate pieces, fruits, marshmallows, sugar-based confections, cocoa powder, or cookies.

25. The process of claim 24, wherein the solid mixture is 39 to 47% of the total weight of the product.

26. A process for producing an ice cream or frozen dessert powder mix, the process consisting of:
grinding and blending a plurality of ingredients at 300 to 1000 rotations per minute (RPM) and at a low shear angle in a first blending device;
grinding and blending the plurality of ingredients at 3500 to 5000 RPM and at a high shear angle in a second blending device;
cooling the plurality of ingredients;
grinding the plurality of ingredients at 300 to 1000 RPM and at the low shear angle in the first blending device; and
mixing the plurality of ingredients at 300 to 1000 RPM in the first blending device to produce a powder mix from the plurality of ingredients.

27. The process of claim 26, wherein the powder mix of the plurality of ingredients has a particle size between 0.3 millimeters to 0.6 millimeters.
